(19) United States
(12) Patent Application Publication
(10) Pub. No.: US 2024/0388481 A1
(43) Pub. Date: Nov. 21, 2024

(54) ENCODING AND DECODING ACKNOWLEDGEMENT SEQUENCES

(71) Applicant: QUALCOMM INCORPORATED, San Diego, CA (US)

(72) Inventors: Ahmed ELSHAFIE, San Diego, CA (US); Hung Dinh LY, San Diego, CA (US); Alexandros MANOLAKOS, Escondido, CA (US)

(21) Appl. No.: 18/564,950

(22) PCT Filed: Aug. 29, 2022
(86) PCT No.: PCT/US2022/075587

§ 371 Date: Nov. 28, 2023

(30) Foreign Application Priority Data
Aug. 30, 2021 (GR) 20210100575

(51) Int. Cl. H04L 27/20

(52) U.S. Cl. CPC H04L 27/20

(57) ABSTRACT

Various aspects of the present disclosure generally relate to wireless communication. In some aspects, a user equipment (UE) may encode a sequence associated with an acknowledgement status using a symmetric key. The symmetric key may be determined using channel reciprocity at a physical layer or may be determined using a higher layer of the UE. Accordingly, the UE may transmit the sequence associated with the acknowledgement status. Numerous other aspects are described.

### CROSS-REFERENCE TO RELATED APPLICATION

This patent application claims priority to Greek Patent Application No. 20210100575, filed on Aug. 30, 2021, entitled “ENCODING AND DECODING ACKNOWLEDGEMENT SEQUENCES.” The disclosure of the prior application is considered part of and is incorporated by reference in this patent application.

### FIELD OF THE DISCLOSURE

Aspects of the present disclosure generally relate to wireless communication and to techniques and apparatuses for encoding and decoding acknowledgement sequences.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to encode a sequence associated with an acknowledgement status using a symmetric key. The one or more processors may be configured to transmit the sequence associated with the acknowledgement status.

Some aspects described herein relate to an apparatus for wireless communication at a network entity. The apparatus may include a memory and one or more processors coupled to the memory. The one or more processors may be configured to receive a sequence associated with an acknowledgement status. The one or more processors may be configured to decode the sequence using a symmetric key.

Some aspects described herein relate to an apparatus for wireless communication at a UE. The apparatus may include a memory and one or more processors coupled to the memory. The one or more processors may be configured to encode an acknowledgement status using a symmetric key. The one or more processors may be configured to transmit a sequence associated with the encoded acknowledgement status.

Some aspects described herein relate to a method of wireless communication performed by a UE. The method may include encoding a sequence associated with an acknowledgement status using a symmetric key. The method may include transmitting the sequence associated with the acknowledgement status.

Some aspects described herein relate to a method of wireless communication performed by a network entity. The method may include receiving a sequence associated with an acknowledgement status. The method may include decoding the sequence using a symmetric key.

Some aspects described herein relate to a method of wireless communication performed by a UE. The method may include encoding an acknowledgement status using a symmetric key. The method may include transmitting a sequence associated with the encoded acknowledgement status.

Some aspects described herein relate to a non-transitory computer-readable medium that stores a set of instructions for wireless communication by a UE. The set of instructions, when executed by one or more processors of the UE, may cause the UE to encode a sequence associated with an acknowledgement status using a symmetric key. The set of instructions, when executed by one or more processors of the UE, may cause the UE to transmit the sequence associated with the acknowledgement status.

Some aspects described herein relate to a non-transitory computer-readable medium that stores a set of instructions for wireless communication by a network entity. The set of instructions, when executed by one or more processors of the network entity, may cause the network entity to receive a sequence associated with an acknowledgement status. The set of instructions, when executed by one or more processors of the network entity, may cause the network entity to decode the sequence using a symmetric key.

Some aspects described herein relate to a non-transitory computer-readable medium that stores a set of instructions for wireless communication by a UE. The set of instructions, when executed by one or more processors of the UE, may cause the UE to encode an acknowledgement status using a symmetric key. The set of instructions, when executed by one or more processors of the UE, may cause the UE to transmit a sequence associated with the encoded acknowledgement status.

Some aspects described herein relate to an apparatus for wireless communication. The apparatus may include means for encoding a sequence associated with an acknowledgement status using a symmetric key. The apparatus may include means for transmitting the sequence associated with the acknowledgement status.

Some aspects described herein relate to an apparatus for wireless communication. The apparatus may include means for receiving a sequence associated with an acknowledgement status. The apparatus may include means for decoding the sequence using a symmetric key.

Some aspects described herein relate to an apparatus for wireless communication. The apparatus may include means for encoding an acknowledgement status using a symmetric key. The apparatus may include means for transmitting a sequence associated with the encoded acknowledgement status.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment in a wireless network, in accordance with the present disclosure.

FIG. 3 is a diagram illustrating an example disaggregated base station architecture, in accordance with the present disclosure.

FIG. 4 is a diagram illustrating an example associated with generating a symmetric key, in accordance with the present disclosure.

FIG. 5 is a diagram illustrating an example associated with encoding and decoding acknowledgement sequences, in accordance with the present disclosure.

FIGS. 6, 7, and 8 are diagrams illustrating example processes associated with encoding and decoding acknowledgement sequences, in accordance with the present disclosure.

FIGS. 9 and 10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

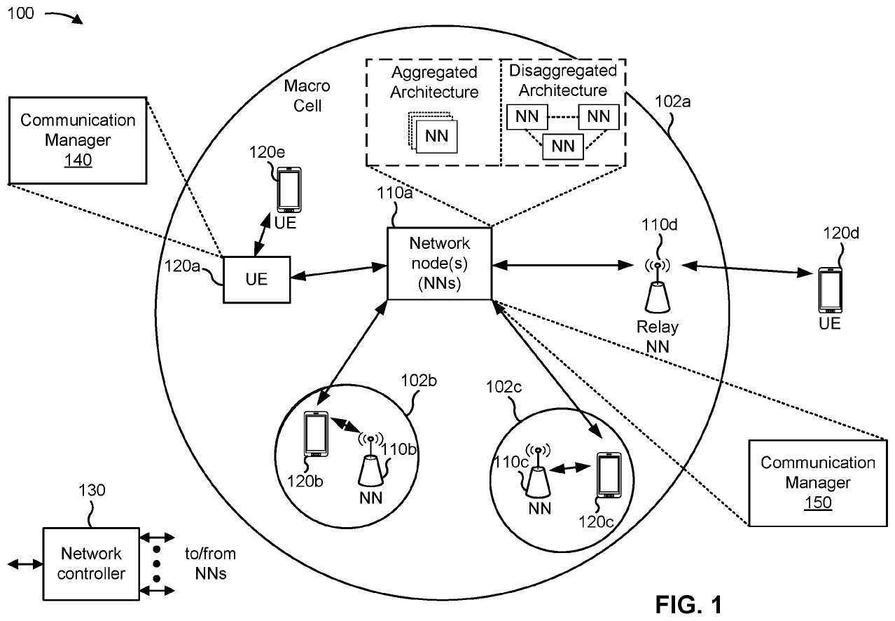

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As shown in FIG. 1 and as described in more detail elsewhere herein, the communication manager 140 may encode a sequence associated with an acknowledgement status using a symmetric key and may transmit (e.g., to the network node 110) the sequence associated with the acknowledgement status. Additionally, or alternatively, the communication manager 140 may encode an acknowledgement status using a symmetric key and may transmit (e.g., to the network node 110) a sequence associated with the encoded acknowledgement status. Additionally, or alternatively, the communication manager 140 may perform one or more other operations described herein.

In some aspects, a network entity (e.g., the network node 110) may include a communication manager 150. As shown in FIG. 1 and as described in more detail elsewhere herein, the communication manager 150 may receive (e.g., from the UE 120) a sequence associated with an acknowledgement status and may decode the sequence using a symmetric key. Additionally, or alternatively, the communication manager 150 may perform one or more other operations described herein.

As indicated above, FIG. 1 is provided as an example. Other examples may differ from what is described with regard to FIG. 1.

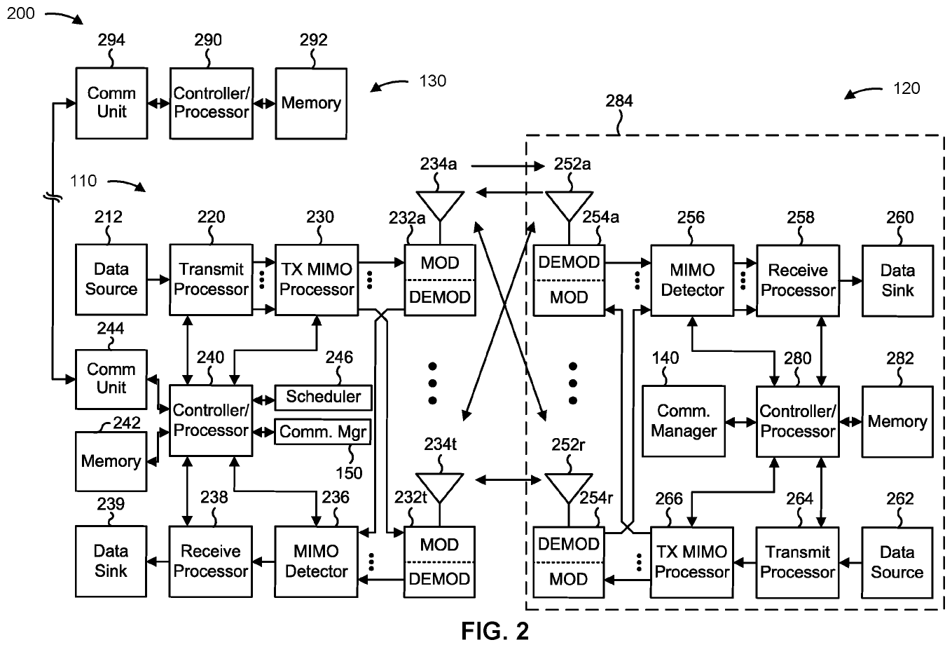

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

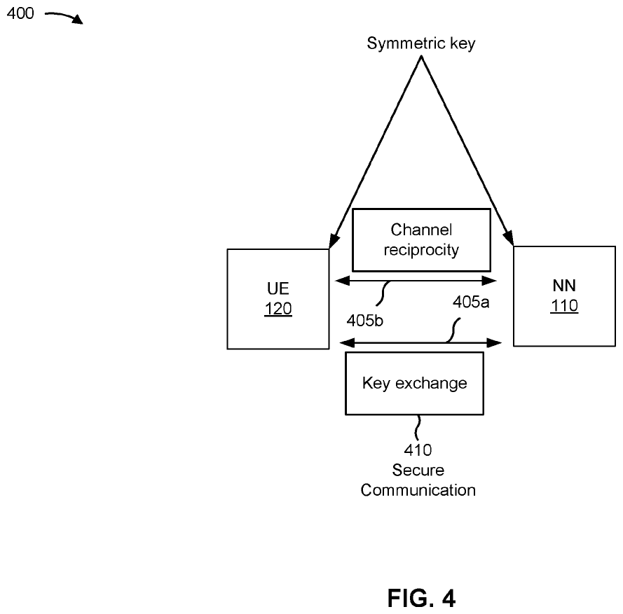

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

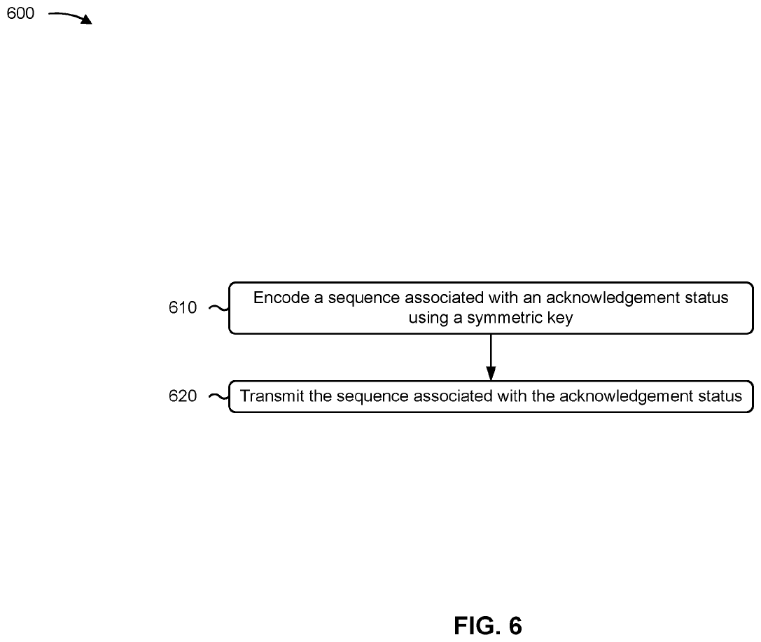

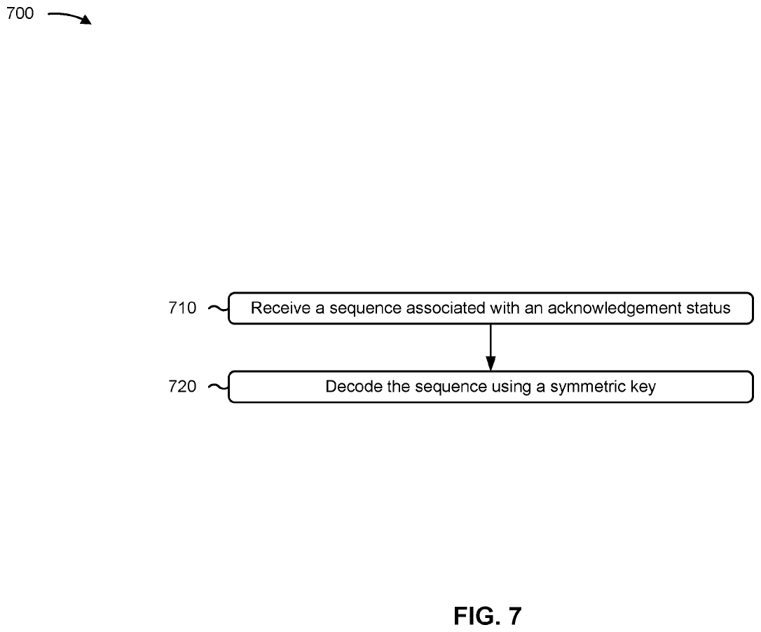

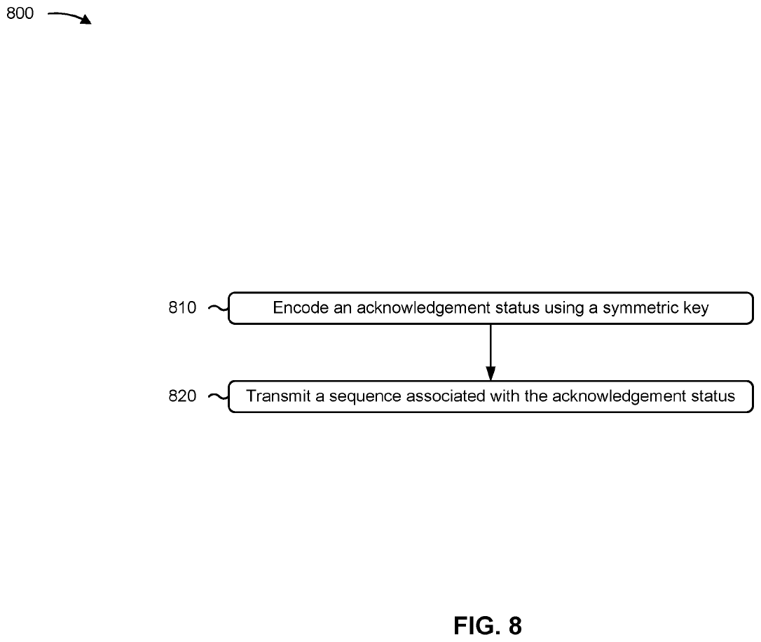

The controller/processor 240 of the network node 110, the controller/processor 280 of the UE 120, and/or any other component(s) of FIG. 2 may perform one or more techniques associated with encoding and decoding acknowledgement sequences, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, and/or other processes as described herein. In some examples, executing instructions may include running the instructions, converting the instructions, compiling the instructions, and/or interpreting the instructions, among other examples.

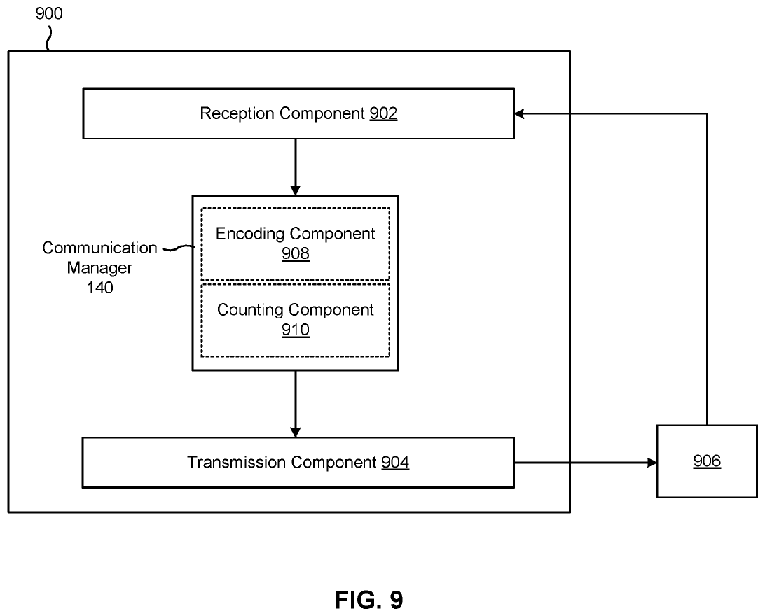

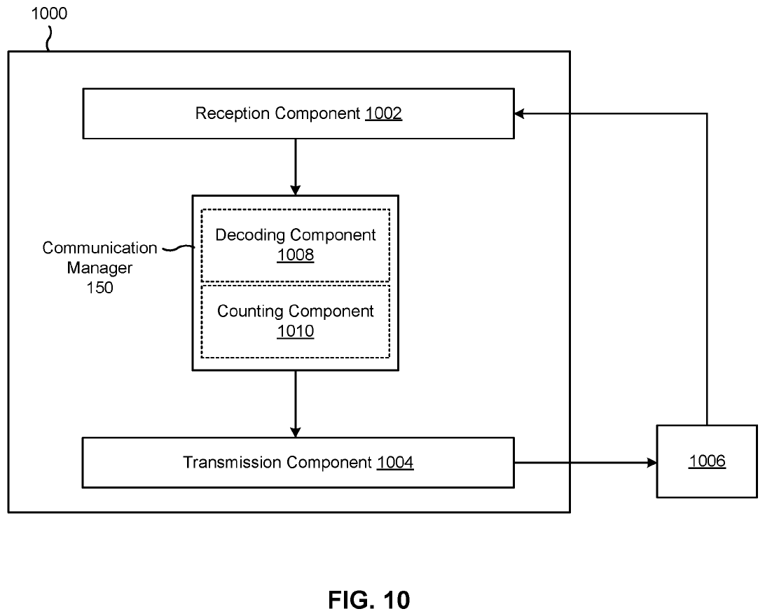

In some aspects, a UE (e.g., the UE 120 and/or apparatus 900 of FIG. 9) may include means for encoding a sequence associated with an acknowledgement status using a symmetric key and/or means for transmitting (e.g., to a network, via the network node 110 and/or apparatus 1000 of FIG. 10) the sequence associated with the acknowledgement status. Additionally, or alternatively, the UE may include means for encoding an acknowledgement status using a symmetric key and/or means for transmitting (e.g., to a network, via the network node 110 and/or apparatus 1000 of FIG. 10) a sequence associated with the encoded acknowledgement status. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the network node 110 and/or apparatus 1000 of FIG. 10) may include means for receiving (e.g., from a UE, such as the UE 120 and/or apparatus 900 of FIG. 9) a sequence associated with an acknowledgement status and/or means for decoding the sequence using a symmetric key. The means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an JAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

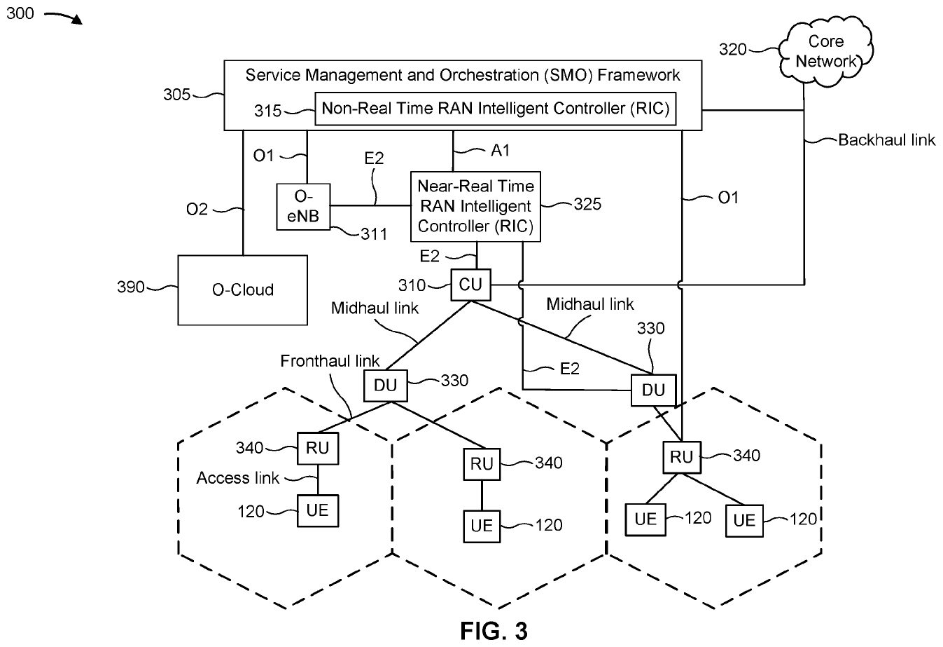

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Acknowledgement signals, such as hybrid automatic repeat request (HARQ) acknowledgements (ACKs) and negative-acknowledgements (NACKs), are frequently transmitted from a UE to a network to indicate whether data payloads from the network were received by the UE. In 3GPP specifications, HARQ feedback is usually transmitted on a physical uplink control channel (PUCCH) according to format 0. These acknowledgement signals are typically sequences transmitted over-the-air (OTA) to the network. Because the sequences are generated according to 3GPP specifications or another standard, the sequences can be intercepted by malicious actors. If a malicious actor were to obtain acknowledgement signals from a UE, the malicious actor could degrade throughput to the UE by transmitting fake data payloads to the UE in response to the acknowledgement signals. Additionally, the UE would waste power and processing resources on receiving and attempting to decode the fake data payloads.

Some techniques and apparatuses described herein enable a UE (e.g., UE 120) to encode a sequence, associated with an acknowledgement status, using a symmetric key. Accordingly, a network node (e.g., network node 110) can decode the sequence and determine the associated acknowledgement status using the symmetric key. As a result, the acknowledgement status is secured against interception by malicious actors. Accordingly, malicious actors cannot degrade throughput to the UE 120 based on the acknowledgement signals. Additionally, malicious actors cannot cause the UE 120 to waste power and processing resources on receiving and attempting to decode fake data payloads.

FIG. 4 is a diagram illustrating an example 400 associated with generating a symmetric key, in accordance with the present disclosure. As shown in FIG. 4, example 400 includes communication between a network node 110 (e.g., an RU 340 or a device controlling the RU 340, such as a DU 330 and/or a CU 310) and a UE 120. In some aspects, the network node 110 and the UE 120 may be included in a wireless network, such as wireless network 100 of FIG. 1.

In some aspects, the network node 110 and the UE 120 may establish a secure channel 405a. For example, the secure channel 405a may use UEA2 confidentiality and UIA2 integrity algorithms as defined by 3GPP specifications. Other encryption algorithms may be used to encrypt data transmitted over the secure channel 405a.

Accordingly, higher layers of the network node 110 and/or the UE 120 may generate a key and transmit the key on the secure channel 405a using a secure communication 410. As used herein, “higher layer” may refer to a MAC layer, an RLC layer, a PDCP layer, or an RRC layer, among other examples. For example, the network node 110 and the UE 120 may use a Diffie-Hellman key exchange and/or another technique that uses Rivest-Shamir-Adleman (RSA). In another example, the network node 110 and the UE 120 may use elliptic-curve cryptography (ECC) to generate and exchange a key. Accordingly, the network node 110 and the UE 120 rely on an exchange to generate a symmetric key.

As an alternative, the network node 110 and the UE 120 may use reciprocity on a channel 405b between the UE 120 and the network node 110 in order to generate keys. Accordingly, a lower layer of the network node 110 and the UE 120 may rely on reciprocity to generate a symmetric key rather than an exchange. As used herein, “lower layer” may refer to a PHY layer. As a result, the channel 405b may be, but need not be, a secure channel between the UE 120 and the network node 110.

For example, the network node 110 may calculate a key based at least in part on one or more properties of the channel 405b (e.g., by converting a CQI, a precoding matrix indicator (PMI), a layer indicator (LI), a rank indicator (RI), an RSRP, an RSSI, and/or another measurement associated with the channel 405b to a digital or binary key). The network node 110 may estimate the one or more properties using a sounding reference signal (SRS) and/or another signal from the UE 120. Similarly, the UE 120 may calculate the key based at least in part on the same one or more properties of the channel 405b (e.g., by converting a CQI, a PMI, an LI, an RI, an RSRP, an RSSI, and/or another measurement associated with the channel 405b to a digital or binary key). The UE 120 may estimate the one or more properties using a channel state information (CSI) reference signal (CSI-RS) and/or another signal from the network node 110. In some aspects, the network node 110 may indicate to the UE 120 which measurement(s) to use to calculate the key. Additionally, or alternatively, the network node 110 and the UE 120 may be programmed (and/or otherwise preconfigured) with the measurement(s) to use to calculate the key (e.g., according to 3GPP specifications and/or another standard). In a combinatory example, the network node 110 may indicate to the UE 120 which measurement(s) to use out of a plurality of possible measurements that are programmed and/or otherwise preconfigured (e.g., according to 3GPP specifications and/or another standard).

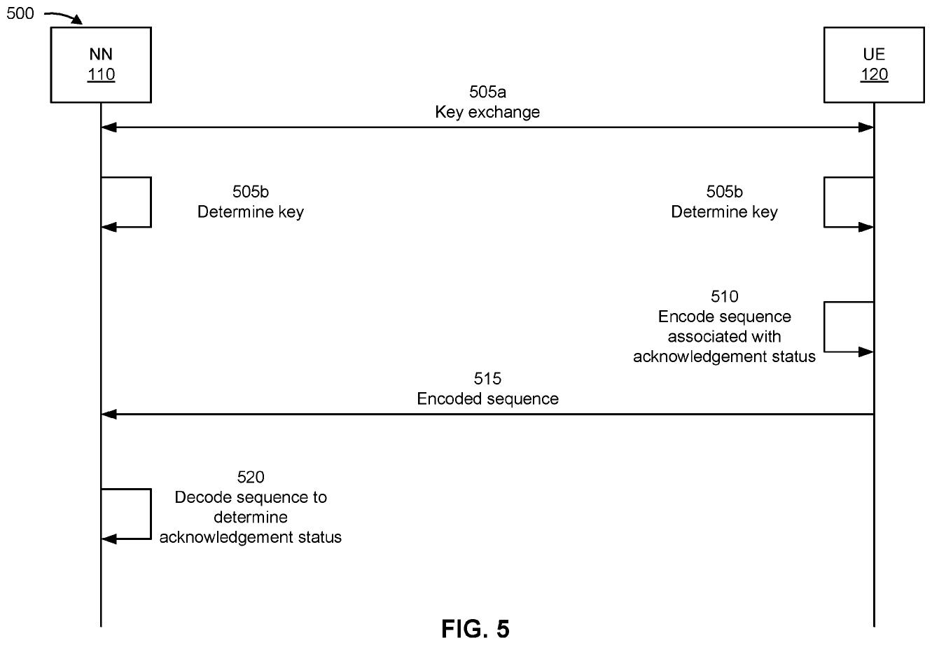

By using techniques as described in connection with FIG. 4, the network node 110 and the UE 120 may generate a symmetric key to use for encoding and decoding acknowledgement sequences. For example, the network node 110 and the UE 120 may use the symmetric key as described in connection with FIG. 5.

As indicated above, FIG. 4 is provided as an example. Other examples may differ from what is described with respect to FIG. 4.

FIG. 5 is a diagram illustrating an example 500 associated with encoding and decoding acknowledgement sequences, in accordance with the present disclosure. As shown in FIG. 5, a network node 110 (e.g., an RU 340 or a device controlling the RU 340, such as DU 330 and/or CU 310) and a UE 120 may communicate with one another (e.g., on a wireless network, such as wireless network 100 of FIG. 1).

As shown by reference number 505a, the UE 120 and the network node 110 may exchange a symmetric key. For example, as described in connection with FIG. 4, higher layers of the UE 120 and/or the network node 110 may generate a key and exchange the key using a secure channel (e.g., channel 405a of FIG. 4). Accordingly, the UE 120 may determine the key and transmit the same to the network node 110 such that the network node 110 determines the key based on receiving the key from the UE 120. As a result, the key is symmetric. As an alternative, the network node 110 may determine the key and transmit the same to the UE 120 such that the UE 120 determines the key based on receiving the key from the network node 110. As a result, the key is symmetric.

As an alternative, and as shown by reference number 505b, the UE 120 and the network node 110 may each determine a symmetric key. For example, as described in connection with FIG. 4, a lower layer of the UE 120 and a lower layer of the network node 110 may each determine a key using channel reciprocity (e.g., on channel 405b of FIG. 4). As a result, the key is symmetric.

In some aspects, the symmetric key includes a quantity of bits that is less than a maximum quantity of bits. For example, the maximum quantity of bits may be represented by N. In some aspects, the maximum quantity of bits is preconfigured (e.g., 3GPP specifications and/or another standard specify a value for N). Additionally, or alternatively, the network node 110 may transmit, and the UE 120 may receive, an indication of the maximum quantity of bits. In a combinatory example, the network node 110 may indicate the maximum quantity of bits selected from a plurality of possible maxima (e.g., preconfigured according to 3GPP specifications and/or another standard that specifies possible values for N).

As shown by reference number 510, the UE 120 may encode a sequence associated with an acknowledgement status. In some aspects, the acknowledgement status is a HARQ ACK, a HARQ NACK, or a combination thereof. For example, the UE 120 may encode a sequence associated with a single ACK, a single NACK, a combination of two ACKs, a combination of two NACKs, a combination of an ACK followed by a NACK, a combination of a NACK followed by an ACK, and so on.

The sequence may be based at least in part on a computer generated sequence that is phase shifted according to the symmetric key. In some aspects, the computer generated sequence may be preconfigured. For example, the UE 120 may use example Table 1 below to determine the sequence to use.

TABLE 1

| Index u | φ(0) | φ(1) | φ(2) | φ(3) | φ(4) | φ(5) |
|---|---|---|---|---|---|---|
| 0 | −3 | −1 | 3 | 3 | −1 | −3 |
| 1 | −3 | 3 | −1 | −1 | 3 | −3 |
| 2 | −3 | −3 | −3 | 3 | 1 | −3 |
| 3 | 1 | 1 | 1 | 3 | −1 | −3 |
| 4 | 1 | 1 | 1 | −3 | −1 | 3 |
| 5 | −3 | 1 | −1 | −3 | −3 | −3 |
| 6 | −3 | 1 | 3 | −3 | −3 | −3 |
| 7 | −3 | −1 | 1 | −3 | 1 | −1 |
| 8 | −3 | −1 | −3 | 1 | −3 | −3 |
| 9 | −3 | −3 | 1 | −3 | 3 | −3 |
| 10 | −3 | 1 | 3 | 1 | −3 | −3 |
| 11 | −3 | −1 | −3 | 1 | 1 | −3 |
| 12 | 1 | 1 | 3 | −1 | −3 | 3 |
| 13 | 1 | 1 | 3 | 3 | −1 | 3 |
| 14 | 1 | 1 | 1 | −3 | 3 | −1 |
| 15 | 1 | 1 | 1 | −1 | 3 | −3 |
| 16 | −3 | −1 | −1 | −1 | 3 | −1 |
| 17 | −3 | −3 | −1 | 1 | −1 | −3 |
| 18 | −3 | −3 | −3 | 1 | −3 | −1 |
| 19 | −3 | 1 | 1 | −3 | −1 | −3 |
| 20 | −3 | 3 | −3 | 1 | 1 | −3 |
| 21 | −3 | 1 | −3 | −3 | −3 | −1 |
| 22 | 1 | 1 | −3 | 3 | 1 | 3 |
| 23 | 1 | 1 | −3 | −3 | 1 | −3 |
| 24 | 1 | 1 | 3 | −1 | 3 | 3 |
| 25 | 1 | 1 | −3 | 1 | 3 | 3 |
| 26 | 1 | 1 | −1 | −1 | 3 | −1 |
| 27 | 1 | 1 | −1 | 3 | −1 | −1 |
| 28 | 1 | 1 | −1 | 3 | −3 | −1 |
| 29 | 1 | 1 | −3 | 1 | −1 | −1 |

As shown in Table 1, the UE 120 may use an index value (e.g., represented by u) to determine the sequence values (e.g., represented by a function φ(n)). Additional or alternative Tables may be used (e.g., according to 3GPP specifications and/or another standard).

Additionally, or alternatively, the UE 120 may use a formula to determine the computer generated sequence. For example, the UE 120 may determine the computer generated sequence according to a form similar to

$$q = ⌊ \overline{q} + \frac{1}{2} ⌋ + v \cdot {( - 1 )}^{⌊ 2 \overline{q} ⌋} , where \\ \overline{q} = {N}_{ZC} \cdot ( u + 1 ) / 31 ,$$

where the sequence values are represented by the function q, a sequence number is represented by ν (and may be set to 0, 1, or another integer based on sequence hopping associated with an uplink channel used to transmit the sequence), an index value is represented by u, and a largest prime number smaller than a length of the computer generated sequence is represented by N_{ZC}.

Accordingly, the UE 120 may convert the symmetric key into a phase shift that is applied to the computer generated sequence. For example, the UE 120 may select from a set of phase shifts

$$( e . g . , a set ϕ = \{ 0 , \frac{π}{6} , \frac{π}{3} , π , … \} )$$

based on the key (e.g., to which integer the key corresponds). In some aspects, the UE 120 may apply the phase shift to the computer generated sequence as selected from Table 1 or function q, among other examples. Additionally, or alternatively, the UE 120 may perform processing on the computer generated sequence and apply the phase shift during processing. In one example, the UE 120 may apply processing with the phase shift ϕ according to a form similar to

$${\overline{r}}_{u , v} ( n ) = {x}_{q} ( n mod {N}_{ZC} ) , where \\ {x}_{q} ( m ) = {e}^{- j ϕ \frac{π qm ( m + 1 )}{{N}_{ZC}}} ,$$

where the processed sequence values are represented by the function r̅_{u,v}(n) and the partially-processed sequence values are represented by the function x_{q}(m).

In another example, the UE 120 may apply processing with the phase shift ϕ according to a form similar to

$${\overline{r}}_{u , v} ( n ) = {e}^{j ϕ φ ( n ) π / 4} ,$$

where the processed sequence values are represented by the function r̅_{u,v}(n).

In another example, the UE 120 may apply processing with the phase shift ϕ according to a form similar to

$${\overline{r}}_{u , v} ( n ) = {e}^{j ϕ \frac{π ( u + 1 ) ( n + 1 ) ( n + 2 )}{31}} ,$$

where the processed sequence values are represented by the function r̅_{u,v}(n).

Additionally, or alternatively, the sequence is based at least in part on a computer generated sequence associated with an index that is selected using the symmetric key. For example, the UE 120 may convert the key to an integer that is used as the index u in order to select and/or calculate the computer generated sequence. In some aspects, the network node 110 may transmit, and the UE 120 may receive, a parameter (e.g., represented by k′). Accordingly, the UE 120 may select index u using the symmetric key and the parameter. For example, the UE 120 may perform an XOR operation on, or apply an Advanced Encryption Standard (AES) algorithm to, the key (e.g., in binary representation) and the parameter k′ in order to determine the index u. As used herein, “AES algorithm” refers to a Rijndael block cipher adopted by the U.S. National Institute of Standards and Technology (NIST) or another Rijndael block cipher that includes a series of one or more additions (e.g., using bitwise XOR), non-linear substitutions, transpositions, and linear mixings.

In some aspects, the UE 120 may apply a combination of the phase shift p based on the symmetric key and selection of the index u based on the symmetric key. For example, the UE 120 may select and/or calculate the computer generated sequence using the index u based on the symmetric key (e.g., determined using an XOR operation on, or an AES algorithm applied to, a binary representation of the key and a parameter k′ from the network node 110) and then perform a phase shift on the computer generated sequence according to the key (e.g., converted into the phase shift).

Additionally, or alternatively, an initial cyclic shift associated with the sequence is selected using the symmetric key. For example, the UE 120 may apply a cyclic shift (e.g., represented by α) according to a form similar to

$${r}_{u , v}^{( α , δ )} = {e}^{j α n} {\overline{r}}_{u , v} ( n ) ,$$

where the shifted sequence values are represented by the function r_{u,v}^{(a,δ)} and δ represents a value based on a length of the computer generated sequence (e.g., determined according to a form similar to M_{ZC}=mN_{SC}^{RB}/2^{δ}, where M_{ZC} represents a length of the computer generated sequence and N_{SC}^{RB} represents a quantity of resource blocks (RBs) per subcarrier associated with the uplink channel used to transmit the sequence).

Accordingly, the UE 120 may determine the cyclic shift α based on the key. In one example, the cyclic shift α is based on one or more bits representing the acknowledgement status (e.g., a bit 0 for NACK, a bit 1 for ACK, a pair of bits {0, 0} for two NACKs, a pair of bits {0, 1} for a NACK followed by an ACK, a pair of bits {1, 1} for two ACKs, a pair of bits {1, 0} for an ACK followed by a NACK, and so on). For example, the cyclic shift α may be based at least in part on an initial cyclic shift (e.g., represented by Cᵢₙᵢₜᵢₐₗ) and associated with a NACK or with two NACKs. The initial cyclic shift may be rotated to represent other possible acknowledgement statuses. For example, Cᵢₙᵢₜᵢₐₗ+6 may be associated with an ACK or with two ACKs, Cᵢₙᵢₜᵢₐₗ+3 may be associated with a NACK followed by an ACK, Cᵢₙᵢₜᵢₐₗ+9 may be associated with an ACK followed by a NACK, and so on. The cyclic shift calculations described herein may also undergo a modulo function. For example, the initial cyclic shift may be input to a modulus function with a quantity of resource elements (REs) used. 3GPP specifications use twelve REs, such that the initial cyclic shift for NACK is set to Cᵢₙᵢₜᵢₐₗ mod 12 and similarly for other acknowledgement statuses, but fewer REs (e.g., eleven, ten, and so on) or additional REs (e.g., thirteen, fourteen, and so on) may be used as an alternative. Accordingly, the UE 120 may determine whether to reverse which initial cyclic shifts are associated with NACK or ACK (or combinations thereof). For example, the UE 120 may select the initial cyclic shift using an XOR operation on, or an AES algorithm applied to, a bit associated with the initial cyclic shift (e.g., a bit or bits representing the acknowledgement status) and the symmetric key (e.g., a binary representation of the key).

In order to ensure that the UE 120 does not use the same determination whether to reverse which initial cyclic shifts for future sequences (which would decrease security of future sequences), the UE 120 may maintain a counter across slots, symbols, or component carrier (CC) indices. For example, the UE 120 may increment the counter whenever the UE 120 proceeds to a next slot (or at least to a subsequent slot in which the UE 120 will transmit a sequence associated with an acknowledgement status), to a next symbol (or at least to a subsequent slot in which the UE 120 will transmit a sequence associated with an acknowledgement status), or changes CCs. Accordingly, the UE 120 may modify the symmetric key according to the counter. For example, the UE 120 may add the counter to the symmetric key (e.g., an integer representation of the key), subtract the counter from the symmetric key (e.g., an integer representation of the key), and/or perform another arithmetic operation thereon. Additionally, or alternatively, the UE 120 may use an XOR operation on, or an AES algorithm applied to, the counter and the symmetric key (e.g., a binary representation of the key) and/or perform another binary operation thereon.

Additionally, or alternatively, to select the initial cyclic shift, associated with the sequence, using the symmetric key, the network node 110 may transmit, and the UE 120 may receive, a parameter (e.g., represented by g′). Accordingly, the UE 120 may select the initial cyclic shift Cᵢₙᵢₜᵢₐₗ using the symmetric key and the parameter. For example, the UE 120 may perform an XOR operation on, or an AES algorithm applied to, the key (e.g., in binary representation) and the parameter g′ in order to determine the initial cyclic shift Cᵢₙᵢₜᵢₐₗ. In another example, the UE 120 may add the key (e.g., in integer representation) and the parameter g′ in order to determine the initial cyclic shift Cᵢₙᵢₜᵢₐₗ.

In any of the aspects described above, the UE 120 may determine the cyclic shift (e.g., represented by a) according to a form similar to

$$α = \frac{2 π}{{N}_{SC}^{RB}} ( ( {m}_{0} + {m}_{cs} + {n}_{cs} ( {n}_{s , f}^{u} , l + {l}^{′} ) ) mod {N}_{SC}^{RB} ) ,$$

where m₀=Cᵢₙᵢₜᵢₐₗ, m_{cs} is 0, 3, 6, or 9 (as described above in connection with rotating Cᵢₙᵢₜᵢₐₗ), and n_{cs} represents a parameter based on a slot number (e.g., represented by n_{s,f}^{u}) in which the sequence will be transmitted, a symbol number (e.g., represented by l′) associated with a first symbol of the slot in which the sequence will be transmitted, and a symbol number (e.g., represented by l) in which the sequence will be transmitted. Additionally with, or alternatively to, encoding Cᵢₙᵢₜᵢₐₗ using the symmetric key, the UE 120 may encode m_{cs} using the symmetric key. For example, the UE 120 may perform an XOR operation on, or an AES algorithm applied to, the key (e.g., in binary representation) and a parameter (e.g., g′ as described above) in order to determine tm_{cs}. In another example, the UE 120 may add the key (e.g., in integer representation) and the parameter g′ in order to determine m_{cs}. The m_{cs} calculations described herein may also undergo a modulo function. For example, the m_{cs} may be input to a modulus function with a quantity of REs used. 3GPP specifications use twelve REs, but fewer REs (e.g., eleven, ten, and so on) or additional REs (e.g., thirteen, fourteen, and so on) may be used as an alternative

In some aspects, the UE 120 may apply a combination of the phase shift ϕ based on the symmetric key and selection of the initial cyclic shift Cᵢₙᵢₜᵢₐₗ based on the symmetric key. For example, the UE 120 may perform a phase shift on the computer generated sequence according to the key (e.g., converted into the phase shift) and then select and/or calculate the initial cyclic shift Cᵢₙᵢₜᵢₐₗ based on the symmetric key (e.g., determining whether to reverse which initial cyclic shifts are associated with NACK or ACK or combinations thereof). Additionally, or alternatively, the UE 120 may apply a combination of selection of the index u based on the symmetric key and selection of the initial cyclic shift Cᵢₙᵢₜᵢₐₗ based on the symmetric key. For example, the UE 120 may select and/or calculate the computer generated sequence using the index u based on the symmetric key (e.g., determined using an XOR operation on, or an AES algorithm applied to, a binary representation of the key and a parameter k′ from the network node 110) and then select and/or calculate the initial cyclic shift Cᵢₙᵢₜᵢₐₗ based on the symmetric key (e.g., determining whether to reverse which initial cyclic shifts are associated with NACK or ACK or combinations thereof). In some aspects, the UE 120 may apply a combination of the phase shift ϕ based on the symmetric key, selection of the index u based on the symmetric key, and selection of the initial cyclic shift Cᵢₙᵢₜᵢₐₗ based on the symmetric key. For example, the UE 120 may select and/or calculate the computer generated sequence using the index u based on the symmetric key (e.g., determined using an XOR operation on, or an AES algorithm applied to, a binary representation of the key and a parameter k′ from the network node 110), then perform a phase shift on the computer generated sequence according to the key (e.g., converted into the phase shift), and then select and/or calculate the initial cyclic shift Cᵢₙᵢₜᵢₐₗ based on the symmetric key (e.g., determining whether to reverse which initial cyclic shifts are associated with NACK or ACK or combinations thereof).

In another example, the UE 120 may perform a phase shift on the computer generated sequence according to the key (e.g., converted into the phase shift) and then select and/or calculate the initial cyclic shift Cᵢₙᵢₜᵢₐₗ based on the symmetric key (e.g., determined using an XOR operation on, or an AES algorithm applied to, a binary representation of the key and a parameter g′ from the network node 110). Additionally, or alternatively, the UE 120 may apply a combination of selection of the index u based on the symmetric key and selection of the initial cyclic shift Cᵢₙᵢₜᵢₐₗ based on the symmetric key. For example, the UE 120 may select and/or calculate the computer generated sequence using the index u based on the symmetric key (e.g., determined using an XOR operation on, or an AES algorithm applied to, a binary representation of the key and a parameter k′ from the network node 110) and then select and/or calculate the initial cyclic shift Cᵢₙᵢₜᵢₐₗ based on the symmetric key (e.g., determined using an XOR operation on, or an AES algorithm applied to, a binary representation of the key and a parameter g′ from the network node 110). In some aspects, the UE 120 may apply a combination of the phase shift ϕ based on the symmetric key, selection of the index u based on the symmetric key, and selection of the initial cyclic shift Cᵢₙᵢₜᵢₐₗ based on the symmetric key. For example, the UE 120 may select and/or calculate the computer generated sequence using the index u based on the symmetric key (e.g., determined using an XOR operation on, or an AES algorithm applied to, a binary representation of the key and a parameter k′ from the network node 110), then perform a phase shift on the computer generated sequence according to the key (e.g., converted into the phase shift), and then select and/or calculate the initial cyclic shift Cᵢₙᵢₜᵢₐₗ based on the symmetric key (e.g., determined using an XOR operation on, or an AES algorithm applied to, a binary representation of the key and a parameter g′ from the network node 110).

Additionally, or alternatively, the sequence is based at least in part on a computer generated sequence to which the symmetric key is added. For example, the UE 120 may add the key to the computer generated sequence (e.g., represented by φ(n)) or at any of the processing described above performed on the computer generated sequence.

In some aspects, the UE 120 may apply a combination of the phase shift ϕ based on the symmetric key and adding the symmetric key to the computer generated sequence. For example, the UE 120 may perform a phase shift on the computer generated sequence according to the key (e.g., converted into the phase shift) as well as add the symmetric key to the computer generated sequence (e.g., before or after performing the phase shift). Additionally, or alternatively, the UE 120 may apply a combination of selection of the index u based on the symmetric key and adding the symmetric key to the computer generated sequence. For example, the UE 120 may select and/or calculate the computer generated sequence using the index u based on the symmetric key (e.g., determined using an XOR operation on, or an AES algorithm applied to, a binary representation of the key and a parameter k′ from the network node 110) and then add the symmetric key to the computer generated sequence. Additionally, or alternatively, the UE 120 may add the symmetric key to the computer generated sequence and select the initial cyclic shift Cᵢₙᵢₜᵢₐₗ based on the symmetric key. For example, the UE 120 may add the symmetric key to the computer generated sequence and then select and/or calculate the initial cyclic shift Cᵢₙᵢₜᵢₐₗ based on the symmetric key (e.g., determining the initial cyclic shift using an XOR operation on, or an AES algorithm applied to, a binary representation of the key and a parameter g′ from the network node 110 and/or determining whether to reverse which initial cyclic shifts are associated with NACK or ACK or combinations thereof). In some aspects, the UE 120 may apply two or more of the phase shift q based on the symmetric key, selection of the index u based on the symmetric key, and/or selection of the initial cyclic shift Cᵢₙᵢₜᵢₐₗ based on the symmetric key with adding the symmetric key to the computer generated sequence.

Additionally, or alternatively, the sequence is based at least in part on an initial cyclic shift to which the symmetric key is added. For example, the UE 120 may add the key to the initial cyclic shift Cᵢₙᵢₜᵢₐₗ.

In some aspects, the UE 120 may apply a combination of the phase shift ϕ based on the symmetric key and adding the symmetric key to the initial cyclic shift. For example, the UE 120 may perform a phase shift on the computer generated sequence according to the key (e.g., converted into the phase shift) as well as add the symmetric key to the initial cyclic shift. Additionally, or alternatively, the UE 120 may apply a combination of selection of the index u based on the symmetric key and adding the symmetric key to the initial cyclic shift. For example, the UE 120 may select and/or calculate the computer generated sequence using the index u based on the symmetric key (e.g., determined using an XOR operation on, or an AES algorithm applied to, a binary representation of the key and a parameter k′ from the network node 110) and then add the symmetric key to the initial cyclic shift. Additionally, or alternatively, the UE 120 may add the symmetric key to the initial cyclic shift as well as select the initial cyclic shift Cᵢₙᵢₜᵢₐₗ based on the symmetric key. For example, the UE 120 may select and/or calculate the initial cyclic shift Cᵢₙᵢₜᵢₐₗ based on the symmetric key (e.g., determining the initial cyclic shift using an XOR operation on, or an AES algorithm applied to, a binary representation of the key and a parameter g′ from the network node 110 and/or determining whether to reverse which initial cyclic shifts are associated with NACK or ACK or combinations thereof) before adding the symmetric key to the initial cyclic shift. In some aspects, the UE 120 may apply two or more of the phase shift ϕ based on the symmetric key, selection of the index u based on the symmetric key, and/or selection of the initial cyclic shift Cᵢₙᵢₜᵢₐₗ based on the symmetric key with adding the symmetric key to the initial cyclic shift.

In any of the aspects described above, the UE 120 may apply one or more of the phase shift 4 based on the symmetric key, selection of the index u based on the symmetric key, selection of the initial cyclic shift Cᵢₙᵢₜᵢₐₗ based on the symmetric key, adding the symmetric key to the initial cyclic shift, and/or adding the symmetric key to the computer generated sequence according to a programmed (and/or otherwise preconfigured) setting (e.g., consistent with 3GPP specifications and/or another standard). Additionally, or alternatively, the network node 110 may transmit, and the UE 120 may receive, an indication of which technique(s) to apply. In a combinatory example, the network node 110 may indicate one or more techniques from a plurality of preconfigured techniques (e.g., consistent with 3GPP specifications and/or another standard).

Additionally with, or alternatively to, encoding the sequence as described above, the UE 120 may encode the acknowledgement status directly. For example, the UE 120 may determine a codepoint, for determining a sequence to transmit, using an XOR operation on, or an AES algorithm applied to, bits representing the acknowledgement status and the symmetric key (e.g., a binary representation of the key). In order to ensure that the UE 120 does not use the same codepoints in future sequences (which would decrease security of future sequences), the UE 120 may maintain a counter across slots, symbols, or CC indices. For example, the UE 120 may increment the counter whenever the UE 120 proceeds to a next slot (or at least to a subsequent slot in which the UE 120 will transmit a sequence associated with an acknowledgement status), to a next symbol (or at least to a subsequent slot in which the UE 120 will transmit a sequence associated with an acknowledgement status), or changes CCs. Accordingly, the UE 120 may modify the symmetric key according to the counter. For example, the UE 120 may add the counter to the symmetric key (e.g., an integer representation of the key), subtract the counter from the symmetric key (e.g., an integer representation of the key), and/or perform another arithmetic operation thereon. Additionally, or alternatively, the UE 120 may use an XOR operation on, or an AES algorithm applied to, the counter and the symmetric key (e.g., a binary representation of the key) and/or perform another binary operation thereon.

For example, codepoints representing the acknowledgement status may include codepoint 0 (corresponding to a bit 0 for NACK) and codepoint 1 (corresponding to a bit 1 for ACK). Similarly, codepoints representing the acknowledgement status may include codepoint 0 (corresponding to a pair of bits {0, 0} for two NACKs), codepoint 1 (corresponding to a pair of bits {0, 1} for a NACK followed by an ACK), codepoint 2 (corresponding to a pair of bits {1, 1} for two ACKs), and codepoint 3 (corresponding to a pair of bits {1, 0} for an ACK followed by a NACK). The initial cyclic shift described above may be selected according to the codepoint (e.g., Cᵢₙᵢₜᵢₐₗ for codepoint 0), Cᵢₙᵢₜᵢₐₗ+3 for codepoint 1, Cᵢₙᵢₜᵢₐₗ+6 for codepoint 2, and Cᵢₙᵢₜᵢₐₗ+9 for codepoint 3. Accordingly, the UE 120 may XOR the symmetric key with the codepoint (or apply an AES algorithm to the symmetric key and the codepoint) in order to select the initial cyclic shift. For example, for two ACKs represented by {1 1} and for a symmetric key of {1 0}, the UE 120 may XOR the symmetric key with the bits representing the acknowledgement status to obtain {0 1}. Accordingly, the UE 120 uses codepoint 1 (corresponding to a pair of bits {0 1} to select an initial cyclic shift of Cᵢₙᵢₜᵢₐₗ+3. In another example, for a NACK followed by an ACK and for a symmetric key of {1 0}, the UE 120 may XOR the symmetric key with the bits representing the acknowledgement status to obtain {0 0}. Accordingly, the UE 120 uses codepoint 0 (corresponding to a pair of bits {0 0} to select an initial cyclic shift of Cᵢₙᵢₜᵢₐₗ.

Additionally, or alternatively, to select the codepoint using the symmetric key, the network node 110 may transmit, and the UE 120 may receive, a parameter (e.g., represented by g). Accordingly, the UE 120 may select the codepoint using the symmetric key and the parameter. For example, the UE 120 may perform an XOR operation on, or apply an AES algorithm to, the key (e.g., in binary representation) and the parameter g′ and then on bits representing the acknowledgement status in order to determine the codepoint. In another example, the UE 120 may add the key (e.g., in integer representation) and the parameter g′ then perform an XOR operation on, or apply an AES algorithm to, the result and bits representing the acknowledgement status (e.g., subject to a modulus function, as described above) in order to determine the codepoint.

As shown by reference number 515, the UE 120 may transmit, and the network node 110 may receive, the sequence. In some aspects, the UE 120 transmits the sequence is transmitted on a PUCCH. Accordingly, the sequence may be formatted according to format 0 associated with the PUCCH. For example, the UE 120 may map the sequence to one or more RBs on the PUCCH according to a form similar to

$$x ( l \cdot {N}_{SC}^{RB} + n ) = {r}_{u , v}^{( α , δ )} ( n ) ,$$

where x(n) represents the transmitted sequence and l is set to 0 when the acknowledgement status is associated with a single symbol and set to (0,1) when the acknowledgement status is associated with double symbols.

As shown by reference number 520, the network node 110 may decode the sequence. For example, the network node 110 may reverse one or more techniques, as described above, that the UE 120 performed when encoding the sequence. Because the key is symmetric, the network node 110 may reverse the encoding technique(s) performed by the UE 120 to determine the acknowledgement status.

By using techniques as described in connection with FIG. 5, the UE 120 may encode a sequence, associated with an acknowledgement status, using a symmetric key. Accordingly, a network (e.g., via network node 110) can decode the sequence and determine the associated acknowledgement status using the symmetric key. As a result, the acknowledgement status is secured against interception by malicious actors. Accordingly, malicious actors cannot degrade throughput to the UE 120 based on the acknowledgement signals. Additionally, malicious actors cannot cause the UE 120 to waste power and processing resources on receiving and attempting to decode fake data payloads.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120 and/or apparatus 900 of FIG. 9) performs operations associated with encoding acknowledgement sequences.

As shown in FIG. 6, in some aspects, process 600 may include encoding a sequence associated with an acknowledgement status using a symmetric key (block 610). For example, the UE (e.g., using communication manager 140 and/or encoding component 908, depicted in FIG. 9) may encode a sequence associated with an acknowledgement status using a symmetric key, as described herein.

As further shown in FIG. 6, in some aspects, process 600 may include transmitting (e.g., to network node 110 and/or apparatus 1000 of FIG. 10) the sequence associated with the acknowledgement status (block 620). For example, the UE (e.g., using communication manager 140 and/or transmission component 904, depicted in FIG. 9) may transmit the sequence associated with the acknowledgement status, as described herein.

Process 600 may include additional aspects, such as any single aspect or any combination of aspects described below and/or in connection with one or more other processes described elsewhere herein.

In a first aspect, the symmetric key is determined using channel reciprocity at a PHY layer.

In a second aspect, alone or in combination with the first aspect, the symmetric key is determined using a higher layer of the UE.

In a third aspect, alone or in combination with one or more of the first and second aspects, the acknowledgement status includes a HARQ ACK, a HARQ NACK, or a combination thereof.

In a fourth aspect, alone or in combination with one or more of the first through third aspects, the sequence is transmitted on a PUCCH.

In a fifth aspect, alone or in combination with one or more of the first through fourth aspects, the sequence is formatted according to format 0 associated with the PUCCH.

In a sixth aspect, alone or in combination with one or more of the first through fifth aspects, the symmetric key includes a quantity of bits that is less than a maximum quantity of bits.

In a seventh aspect, alone or in combination with one or more of the first through sixth aspects, the maximum quantity of bits is preconfigured.

In an eighth aspect, alone or in combination with one or more of the first through seventh aspects, process 600 includes receiving (e.g., using communication manager 140 and/or reception component 902, depicted in FIG. 9) an indication of the maximum quantity of bits.

In a ninth aspect, alone or in combination with one or more of the first through eighth aspects, the sequence is based at least in part on a computer generated sequence that is phase shifted according to the symmetric key.

In a tenth aspect, alone or in combination with one or more of the first through ninth aspects, the computer generated sequence is preconfigured.

In an eleventh aspect, alone or in combination with one or more of the first through tenth aspects, process 600 includes converting (e.g., using communication manager 140 and/or encoding component 908) the symmetric key into a phase shift that is applied to the computer generated sequence.

In a twelfth aspect, alone or in combination with one or more of the first through eleventh aspects, the sequence is based at least in part on a computer generated sequence associated with an index that is selected using the symmetric key.

In a thirteenth aspect, alone or in combination with one or more of the first through twelfth aspects, process 600 includes receiving (e.g., using communication manager 140 and/or reception component 902) a parameter, such that the index is selected using the symmetric key and the parameter.

In a fourteenth aspect, alone or in combination with one or more of the first through thirteenth aspects, the index is selected using an XOR operation on, or an AES algorithm applied to, the symmetric key and the parameter.

In a fifteenth aspect, alone or in combination with one or more of the first through fourteenth aspects, an initial cyclic shift associated with the sequence is selected using the symmetric key.

In a sixteenth aspect, alone or in combination with one or more of the first through fifteenth aspects, the initial cyclic shift is selected using an XOR operation on, or an AES algorithm applied to, a bit associated with the initial cyclic shift and the symmetric key.

In a seventeenth aspect, alone or in combination with one or more of the first through sixteenth aspects, process 600 includes maintaining (e.g., using communication manager 140 and/or counting component 910, depicted in FIG. 9) a counter across slots, symbols, or component carrier indices, such that the symmetric key is modified according to the counter.

In an eighteenth aspect, alone or in combination with one or more of the first through seventeenth aspects, process 600 includes receiving (e.g., using communication manager 140 and/or reception component 902) a parameter, such that the initial cyclic shift is selected using the symmetric key and the parameter.

In a nineteenth aspect, alone or in combination with one or more of the first through eighteenth aspects, the initial cyclic shift is selected using an XOR operation on, or an AES algorithm applied to, the symmetric key and the parameter.

In a twentieth aspect, alone or in combination with one or more of the first through nineteenth aspects, the sequence is based at least in part on a computer generated sequence to which the symmetric key is added.

In a twenty-first aspect, alone or in combination with one or more of the first through twentieth aspects, the sequence is based at least in part on an initial cyclic shift to which the symmetric key is added.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network entity, in accordance with the present disclosure. Example process 700 is an example where the network entity (e.g., network node 110 and/or apparatus 1000 of FIG. 10) performs operations associated with decoding acknowledgement sequences.

As shown in FIG. 7, in some aspects, process 700 may include receiving (e.g., from UE 120 and/or apparatus 900 of FIG. 9) a sequence associated with an acknowledgement status (block 710). For example, the network entity (e.g., using communication manager 150 and/or reception component 1002, depicted in FIG. 10) may receive a sequence associated with an acknowledgement status, as described herein.

As further shown in FIG. 7, in some aspects, process 700 may include decoding the sequence using a symmetric key (block 720). For example, the network entity (e.g., using communication manager 150 and/or decoding component 1008, depicted in FIG. 10) may decode the sequence using a symmetric key, as described herein.

Process 700 may include additional aspects, such as any single aspect or any combination of aspects described below and/or in connection with one or more other processes described elsewhere herein.

In a first aspect, the symmetric key is determined using channel reciprocity at a PHY layer.

In a second aspect, alone or in combination with the first aspect, the symmetric key is determined using a higher layer of the network entity.

In a third aspect, alone or in combination with one or more of the first and second aspects, the acknowledgement status includes a HARQ ACK, a HARQ NACK, or a combination thereof.

In a fourth aspect, alone or in combination with one or more of the first through third aspects, the sequence is received on a PUCCH.

In a fifth aspect, alone or in combination with one or more of the first through fourth aspects, the sequence is formatted according to format 0 associated with the PUCCH.

In a sixth aspect, alone or in combination with one or more of the first through fifth aspects, the symmetric key includes a quantity of bits that is less than a maximum quantity of bits.

In a seventh aspect, alone or in combination with one or more of the first through sixth aspects, the maximum quantity of bits is preconfigured.

In an eighth aspect, alone or in combination with one or more of the first through seventh aspects, process 700 includes transmitting (e.g., using communication manager 150 and/or transmission component 1004, depicted in FIG. 10) an indication of the maximum quantity of bits.

In a ninth aspect, alone or in combination with one or more of the first through eighth aspects, the sequence is based at least in part on a computer generated sequence that is phase shifted according to the symmetric key.

In a tenth aspect, alone or in combination with one or more of the first through ninth aspects, the computer generated sequence is preconfigured.

In an eleventh aspect, alone or in combination with one or more of the first through tenth aspects, process 700 includes converting (e.g., using communication manager 150 and/or decoding component 1008) the symmetric key into a phase shift that is applied to the computer generated sequence.

In a twelfth aspect, alone or in combination with one or more of the first through eleventh aspects, the sequence is based at least in part on a computer generated sequence associated with an index that is selected using the symmetric key.

In a thirteenth aspect, alone or in combination with one or more of the first through twelfth aspects, process 700 further includes transmitting (e.g., using communication manager 150 and/or transmission component 1004) a parameter, such that the index is selected using the symmetric key and the parameter.

In a fourteenth aspect, alone or in combination with one or more of the first through thirteenth aspects, the index is selected using an XOR operation on, or an AES algorithm applied to, the symmetric key and the parameter.

In a fifteenth aspect, alone or in combination with one or more of the first through fourteenth aspects, an initial cyclic shift associated with the sequence is selected using the symmetric key.

In a sixteenth aspect, alone or in combination with one or more of the first through fifteenth aspects, the initial cyclic shift is selected using an XOR operation on, or an AES algorithm applied to, a bit associated with the initial cyclic shift and the symmetric key.

In a seventeenth aspect, alone or in combination with one or more of the first through sixteenth aspects, process 700 includes maintaining (e.g., using communication manager 150 and/or counting component 1010, depicted in FIG. 10) a counter across slots, symbols, or component carrier indices, such that the symmetric key is modified according to the counter.

In an eighteenth aspect, alone or in combination with one or more of the first through seventeenth aspects, process 700 includes transmitting (e.g., using communication manager 150 and/or transmission component 1004) a parameter, such that the initial cyclic shift is selected using the symmetric key and the parameter.

In a nineteenth aspect, alone or in combination with one or more of the first through eighteenth aspects, the initial cyclic shift is selected using an XOR operation on, or an AES algorithm applied to, the symmetric key and the parameter.

In a twentieth aspect, alone or in combination with one or more of the first through nineteenth aspects, the sequence is based at least in part on a computer generated sequence to which the symmetric key is added.

In a twenty-first aspect, alone or in combination with one or more of the first through twentieth aspects, the sequence is based at least in part on an initial cyclic shift to which the symmetric key is added.

In a twenty-second aspect, alone or in combination with one or more of the first through twenty-first aspects, the sequence is based at least in part on a codepoint that is selected according to the symmetric key.

In a twenty-third aspect, alone or in combination with one or more of the first through twenty-second aspects, the codepoint is selected using an XOR operation on, or an AES algorithm applied to, the symmetric key and one or more bits representing the acknowledgement status.

In a twenty-fourth aspect, alone or in combination with one or more of the first through twenty-third aspects, process 700 includes transmitting (e.g., using communication manager 140 and/or transmission component 1004) a parameter, such that the codepoint is selected using the symmetric key and the parameter.

In a twenty-fifth aspect, alone or in combination with one or more of the first through twenty-fourth aspects, the codepoint is selected using an XOR operation on, or an AES algorithm applied to, the symmetric key and the parameter.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120 and/or apparatus 900 of FIG. 9) performs operations associated with encoding acknowledgement sequences.

As shown in FIG. 8, in some aspects, process 800 may include encoding an acknowledgement status using a symmetric key (block 810). For example, the UE (e.g., using communication manager 140 and/or encoding component 908, depicted in FIG. 9) may encode an acknowledgement status using a symmetric key, as described herein.

As further shown in FIG. 8, in some aspects, process 800 may include transmitting (e.g., to network node 110 and/or apparatus 1000 of FIG. 10) a sequence associated with the encoded acknowledgement status (block 820). For example, the UE (e.g., using communication manager 140 and/or transmission component 904, depicted in FIG. 9) may transmit a sequence associated with the encoded acknowledgement status, as described herein.

Process 800 may include additional aspects, such as any single aspect or any combination of aspects described below and/or in connection with one or more other processes described elsewhere herein.

In a first aspect, the symmetric key is determined using channel reciprocity at a PHY layer.

In a second aspect, alone or in combination with the first aspect, the symmetric key is determined using a higher layer of the UE.

In a third aspect, alone or in combination with one or more of the first and second aspects, the acknowledgement status comprises a HARQ acknowledgement, a HARQ negative-acknowledgement, or a combination thereof.

In a fourth aspect, alone or in combination with one or more of the first through third aspects, the sequence is transmitted on a PUCCH.

In a fifth aspect, alone or in combination with one or more of the first through fourth aspects, the sequence is formatted according to format 0 associated with the PUCCH.

In a sixth aspect, alone or in combination with one or more of the first through fifth aspects, the symmetric key includes a quantity of bits that is less than a maximum quantity of bits.

In a seventh aspect, alone or in combination with one or more of the first through sixth aspects, the maximum quantity of bits is preconfigured.

In an eighth aspect, alone or in combination with one or more of the first through seventh aspects, process 800 includes receiving (e.g., using communication manager 140 and/or reception component 902, depicted in FIG. 9) an indication of the maximum quantity of bits.

In a ninth aspect, alone or in combination with one or more of the first through eighth aspects, the sequence is based at least in part on a codepoint that is selected according to the symmetric key.

In a tenth aspect, alone or in combination with one or more of the first through ninth aspects, the codepoint is selected using an XOR operation on, or an AES algorithm applied to, the symmetric key and one or more bits representing the acknowledgement status.

In an eleventh aspect, alone or in combination with one or more of the first through tenth aspects, process 800 includes receiving (e.g., using communication manager 140 and/or reception component 902) a parameter, such that the codepoint is selected using the symmetric key and the parameter.

In a twelfth aspect, alone or in combination with one or more of the first through eleventh aspects, the codepoint is selected using an XOR operation on, or an AES algorithm applied to, the symmetric key and the parameter.

In a thirteenth aspect, alone or in combination with one or more of the first through twelfth aspects, process 800 includes maintaining (e.g., using communication manager 140 and/or counting component 910, depicted in FIG. 9) a counter across slots, symbols, or component carrier indices, such that the symmetric key is modified according to the counter.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, an RU, or another wireless communication device) using the reception component 902 and the transmission component 904. As further shown, the apparatus 900 may include the communication manager 140. The communication manager 140 may include one or more of an encoding component 908 and/or a counting component 910, among other examples.

In some aspects, the apparatus 900 may be configured to perform one or more operations described herein in connection with FIGS. 4-5. Additionally, or alternatively, the apparatus 900 may be configured to perform one or more processes described herein, such as process 600 of FIG. 6, process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

In some aspects, the encoding component 908 may encode a sequence associated with an acknowledgement status using a symmetric key. For example, the encoding component 908 may convert the symmetric key into a phase shift that is applied to a computer generated sequence. Accordingly, the transmission component 904 may transmit (e.g., to the apparatus 906) the sequence associated with the acknowledgement status. The encoding component 908 may include a modem, a modulator, a transmit MIMO processor, a transmit processor, a controller/processor, a memory, or a combination thereof, of the UE described in connection with FIG. 2.

In some aspects, the reception component 902 may receive (e.g., from the apparatus 906) an indication of a maximum quantity of bits for the computer generated sequence. Additionally, or alternatively, the reception component 902 may receive (e.g., from the apparatus 906) a parameter, such that an index associated with the computer generated sequence is selected using the symmetric key and the parameter. Additionally, or alternatively, the reception component 902 may receive (e.g., from the apparatus 906) a parameter, such that an initial cyclic shift for the sequence is selected using the symmetric key and the parameter.

In some aspects, the counting component 910 may maintain a counter across slots, symbols, or CC indices such that the encoding component 908 modifies the symmetric key according to the counter. The counting component 910 may include a modem, a demodulator, a MIMO detector, a receive processor, a modulator, a transmit MIMO processor, a transmit processor, a controller/processor, a memory, or a combination thereof, of the UE described in connection with FIG. 2.

Additionally, or alternatively, the encoding component 908 may encode an acknowledgement status using a symmetric key. For example, the encoding component 908 may select a codepoint, using the symmetric key and one or more bits representing the acknowledgement status, to use for generating a sequence. Accordingly, the transmission component 904 may transmit (e.g., to the apparatus 906) the sequence associated with the acknowledgement status.

In some aspects, the reception component 902 may receive (e.g., from the apparatus 906) an indication of a maximum quantity of bits for the sequence. Additionally, or alternatively, the reception component 902 may receive (e.g., from the apparatus 906) a parameter, such that the encoding component 908 selects a codepoint associated with the sequence using the symmetric key and the parameter. Additionally, or alternatively, the reception component 902 may receive (e.g., from the apparatus 906) a parameter, such that the encoding component 908 selects an initial cyclic shift for the sequence using the symmetric key and the parameter.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity, or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 906 (such as a UE, an RU, or another wireless communication device) using the reception component 1002 and the transmission component 1004. As further shown, the apparatus 1000 may include the communication manager 150. The communication manager 150 may include one or more of a decoding component 1008 and/or a counting component 1010, among other examples.

In some aspects, the apparatus 1000 may be configured to perform one or more operations described herein in connection with FIGS. 4-5. Additionally, or alternatively, the apparatus 1000 may be configured to perform one or more processes described herein, such as process 700 of FIG. 7, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

In some aspects, the reception component 1002 may receive (e.g., from the apparatus 1006) a sequence associated with an acknowledgement status. Accordingly, the decoding component 1008 may decode the sequence using a symmetric key. For example, the decoding component 1008 may convert the symmetric key into a phase shift that is applied to a computer generated sequence. The decoding component 1008 may include a modem, a demodulator, a MIMO detector, a receive processor, a controller/processor, a memory, or a combination thereof, of the network node described in connection with FIG. 2.

In some aspects, the transmission component 1004 may transmit (e.g., to the apparatus 1006) an indication of a maximum quantity of bits for the computer generated sequence. Additionally, or alternatively, the transmission component 1004 may transmit (e.g., to the apparatus 1006) a parameter, such that an index associated with the computer generated sequence is selected using the symmetric key and the parameter. Additionally, or alternatively, the transmission component 1004 may transmit (e.g., to the apparatus 1006) a parameter, such that an initial cyclic shift for the sequence is selected using the symmetric key and the parameter.

In some aspects, the counting component 1010 may maintain a counter across slots, symbols, or CC indices such that the symmetric key is modified according to the counter. The counting component 1010 may include a modem, a demodulator, a MIMO detector, a receive processor, a modulator, a transmit MIMO processor, a transmit processor, a controller/processor, a memory, or a combination thereof, of the network node described in connection with FIG. 2.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: encoding a sequence associated with an acknowledgement status using a symmetric key; and transmitting the sequence associated with the acknowledgement status.

Aspect 2: The method of Aspect 1, wherein the symmetric key is determined using channel reciprocity at a physical layer.

Aspect 3: The method of Aspect 1, wherein the symmetric key is determined using a higher layer of the UE.

Aspect 4: The method of any of Aspects 1 through 3, wherein the acknowledgement status comprises a hybrid automatic repeat request (HARQ) acknowledgement, a HARQ negative-acknowledgement, or a combination thereof.

Aspect 5: The method of any of Aspects 1 through 4, wherein the sequence is transmitted on a physical uplink control channel (PUCCH).

Aspect 6: The method of Aspect 5, wherein the sequence is formatted according to format 0 associated with the PUCCH.

Aspect 7: The method of any of Aspects 1 through 6, wherein the symmetric key includes a quantity of bits that is less than a maximum quantity of bits.

Aspect 8: The method of Aspect 7, wherein the maximum quantity of bits is preconfigured.

Aspect 9: The method of any of Aspects 7 through 8, further comprising: receiving an indication of the maximum quantity of bits.

Aspect 10: The method of any of Aspects 1 through 9, wherein the sequence is based at least in part on a computer generated sequence that is phase shifted according to the symmetric key.

Aspect 11: The method of Aspect 10, wherein the computer generated sequence is preconfigured.

Aspect 12: The method of any of Aspects 10 through 11, further comprising: converting the symmetric key into a phase shift that is applied to the computer generated sequence.

Aspect 13: The method of any of Aspects 1 through 12, wherein the sequence is based at least in part on a computer generated sequence associated with an index that is selected using the symmetric key.

Aspect 14: The method of Aspect 13, further comprising: receiving a parameter, wherein the index is selected using the symmetric key and the parameter.

Aspect 15: The method of Aspect 14, wherein the index is selected using an XOR operation on, or an Advanced Encryption Standard (AES) algorithm applied to, the symmetric key and the parameter.

Aspect 16: The method of any of Aspects 1 through 15, wherein an initial cyclic shift associated with the sequence is selected using the symmetric key.

Aspect 17: The method of Aspect 16, wherein the initial cyclic shift is selected using an XOR operation on, or an AES algorithm applied to, a bit associated with the initial cyclic shift and the symmetric key.

Aspect 18: The method of any of Aspects 16 through 17, further comprising: maintaining a counter across slots, symbols, or component carrier indices, wherein the symmetric key is modified according to the counter.

Aspect 19: The method of any of Aspects 16 through 18, further comprising: receiving a parameter, wherein the initial cyclic shift is selected using the symmetric key and the parameter.

Aspect 20: The method of Aspect 19, wherein the initial cyclic shift is selected using an XOR operation on, or an AES algorithm applied to, the symmetric key and the parameter.

Aspect 21: The method of any of Aspects 1 through 20, wherein the sequence is based at least in part on a computer generated sequence to which the symmetric key is added.

Aspect 22: The method of any of Aspects 1 through 21, wherein the sequence is based at least in part on an initial cyclic shift to which the symmetric key is added.

Aspect 23: A method of wireless communication performed by a network entity, comprising: receiving a sequence associated with an acknowledgement status; and decoding the sequence using a symmetric key.

Aspect 24: The method of Aspect 23, wherein the symmetric key is determined using channel reciprocity at a physical layer.

Aspect 25: The method of Aspect 23, wherein the symmetric key is determined using a higher layer of the network entity.

Aspect 26: The method of any of Aspects 23 through 25, wherein the acknowledgement status comprises a hybrid automatic repeat request (HARQ) acknowledgement, a HARQ negative-acknowledgement, or a combination thereof.

Aspect 27: The method of any of Aspects 23 through 26, wherein the sequence is received on a physical uplink control channel (PUCCH).

Aspect 28: The method of Aspect 27, wherein the sequence is formatted according to format 0 associated with the PUCCH.

Aspect 29: The method of any of Aspects 23 through 28, wherein the symmetric key includes a quantity of bits that is less than a maximum quantity of bits.

Aspect 30: The method of Aspect 29, wherein the maximum quantity of bits is preconfigured.

Aspect 31: The method of any of Aspects 29 through 30, further comprising: transmitting an indication of the maximum quantity of bits.

Aspect 32: The method of any of Aspects 23 through 31, wherein the sequence is based at least in part on a computer generated sequence that is phase shifted according to the symmetric key.

Aspect 33: The method of Aspect 32, wherein the computer generated sequence is preconfigured.

Aspect 34: The method of any of Aspects 32 through 33, further comprising: converting the symmetric key into a phase shift that is applied to the computer generated sequence.

Aspect 35: The method of any of Aspects 23 through 34, wherein the sequence is based at least in part on a computer generated sequence associated with an index that is selected using the symmetric key.

Aspect 36: The method of Aspect 35, further comprising: transmitting a parameter, wherein the index is selected using the symmetric key and the parameter.

Aspect 37: The method of Aspect 36, wherein the index is selected using an XOR operation on, or an Advanced Encryption Standard (AES) algorithm applied to, the symmetric key and the parameter.

Aspect 38: The method of any of Aspects 23 through 37, wherein an initial cyclic shift associated with the sequence is selected using the symmetric key.

Aspect 39: The method of Aspect 38, wherein the initial cyclic shift is selected using an XOR operation on, or an AES algorithm applied to, a bit associated with the initial cyclic shift and the symmetric key.

Aspect 40: The method of any of Aspects 38 through 39, further comprising: maintaining a counter across slots, symbols, or component carrier indices, wherein the symmetric key is modified according to the counter.

Aspect 41: The method of any of Aspects 38 through 40, further comprising: transmitting a parameter, wherein the initial cyclic shift is selected using the symmetric key and the parameter.

Aspect 42: The method of Aspect 41, wherein the initial cyclic shift is selected using an XOR operation on, or an AES algorithm applied to, the symmetric key and the parameter.

Aspect 43: The method of any of Aspects 23 through 42, wherein the sequence is based at least in part on a computer generated sequence to which the symmetric key is added.

Aspect 44: The method of any of Aspects 23 through 43, wherein the sequence is based at least in part on an initial cyclic shift to which the symmetric key is added.

Aspect 45: A method of wireless communication performed by a user equipment (UE), comprising: encoding an acknowledgement status using a symmetric key; and transmitting a sequence associated with the encoded acknowledgement status.

Aspect 46: The method of Aspect 45, wherein the symmetric key is determined using channel reciprocity at a physical layer.

Aspect 47: The method of Aspect 45, wherein the symmetric key is determined using a higher layer of the UE.

Aspect 48: The method of any of Aspects 45 through 47, wherein the acknowledgement status comprises a hybrid automatic repeat request (HARQ) acknowledgement, a HARQ negative-acknowledgement, or a combination thereof.

Aspect 49: The method of any of Aspects 45 through 48, wherein the sequence is transmitted on a physical uplink control channel (PUCCH).

Aspect 50: The method of Aspect 49, wherein the sequence is formatted according to format 0 associated with the PUCCH.

Aspect 51: The method of any of Aspects 45 through 50, wherein the symmetric key includes a quantity of bits that is less than a maximum quantity of bits.

Aspect 52: The method of Aspect 51, wherein the maximum quantity of bits is preconfigured.

Aspect 53: The method of any of Aspects 51 through 52, further comprising: receiving an indication of the maximum quantity of bits.

Aspect 54: The method of any of Aspects 45 through 53, wherein the sequence is based at least in part on a codepoint that is selected according to the symmetric key.

Aspect 55: The method of Aspect 54, wherein the codepoint is selected using an XOR operation on, or an Advanced Encryption Standard (AES) algorithm applied to, the symmetric key and one or more bits representing the acknowledgement status.

Aspect 56: The method of any of Aspects 54 through 55, further comprising: receiving a parameter, wherein the codepoint is selected using the symmetric key and the parameter.

Aspect 57: The method of any of Aspects 54 through 56, wherein the codepoint is selected using an XOR operation on, or an AES algorithm applied to, the symmetric key and the parameter.

Aspect 58: The method of any of Aspects 45 through 57, further comprising: maintaining a counter across slots, symbols, or component carrier indices, wherein the symmetric key is modified according to the counter.

Aspect 59: An apparatus for wireless communication at a device, comprising a processor; memory coupled with the processor; and instructions stored in the memory and executable by the processor to cause the apparatus to perform the method of one or more of Aspects 1-22.

Aspect 60: A device for wireless communication, comprising a memory and one or more processors coupled to the memory, the one or more processors configured to perform the method of one or more of Aspects 1-22.

Aspect 61: An apparatus for wireless communication, comprising at least one means for performing the method of one or more of Aspects 1-22.

Aspect 62: A non-transitory computer-readable medium storing code for wireless communication, the code comprising instructions executable by a processor to perform the method of one or more of Aspects 1-22.

Aspect 63: A non-transitory computer-readable medium storing a set of instructions for wireless communication, the set of instructions comprising one or more instructions that, when executed by one or more processors of a device, cause the device to perform the method of one or more of Aspects 1-22.

Aspect 64: An apparatus for wireless communication at a device, comprising a processor; memory coupled with the processor; and instructions stored in the memory and executable by the processor to cause the apparatus to perform the method of one or more of Aspects 23-44.

Aspect 65: A device for wireless communication, comprising a memory and one or more processors coupled to the memory, the one or more processors configured to perform the method of one or more of Aspects 23-44.

Aspect 66: An apparatus for wireless communication, comprising at least one means for performing the method of one or more of Aspects 23-44.

Aspect 67: A non-transitory computer-readable medium storing code for wireless communication, the code comprising instructions executable by a processor to perform the method of one or more of Aspects 23-44.

Aspect 68: A non-transitory computer-readable medium storing a set of instructions for wireless communication, the set of instructions comprising one or more instructions that, when executed by one or more processors of a device, cause the device to perform the method of one or more of Aspects 23-44.

Aspect 69: An apparatus for wireless communication at a device, comprising a processor; memory coupled with the processor; and instructions stored in the memory and executable by the processor to cause the apparatus to perform the method of one or more of Aspects 45-58.

Aspect 70: A device for wireless communication, comprising a memory and one or more processors coupled to the memory, the one or more processors configured to perform the method of one or more of Aspects 45-58.

Aspect 71: An apparatus for wireless communication, comprising at least one means for performing the method of one or more of Aspects 45-58.

Aspect 72: A non-transitory computer-readable medium storing code for wireless communication, the code comprising instructions executable by a processor to perform the method of one or more of Aspects 45-58.

Aspect 73: A non-transitory computer-readable medium storing a set of instructions for wireless communication, the set of instructions comprising one or more instructions that, when executed by one or more processors of a device, cause the device to perform the method of one or more of Aspects 45-58.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
encode a sequence associated with an acknowledgement status using a symmetric key; and
transmit the sequence associated with the acknowledgement status.

2. The apparatus of claim 1, wherein the symmetric key is determined using channel reciprocity at a physical layer.

3. The apparatus of claim 1, wherein the symmetric key is determined using a higher layer of the UE.

4. The apparatus of claim 1, wherein the acknowledgement status comprises a hybrid automatic repeat request (HARQ) acknowledgement, a HARQ negative-acknowledgement, or a combination thereof.

5. The apparatus of claim 1, wherein the sequence is transmitted on a physical uplink control channel (PUCCH).

6. The apparatus of claim 5, wherein the sequence is formatted according to format 0 associated with the PUCCH.

7. The apparatus of claim 1, wherein the symmetric key includes a quantity of bits that is less than a maximum quantity of bits.

8. The apparatus of claim 7, wherein the maximum quantity of bits is preconfigured.

9. The apparatus of claim 7, wherein the one or more processors are further configured to:
receive an indication of the maximum quantity of bits.

10. The apparatus of claim 1, wherein the sequence is based at least in part on a computer generated sequence that is phase shifted according to the symmetric key.

11. The apparatus of claim 10, wherein the computer generated sequence is preconfigured.

12. The apparatus of claim 10, wherein the one or more processors are further configured to:
convert the symmetric key into a phase shift that is applied to the computer generated sequence.

13. The apparatus of claim 1, wherein the sequence is based at least in part on a computer generated sequence associated with an index that is selected using the symmetric key.

14. The apparatus of claim 13, wherein the one or more processors are further configured to:
receive a parameter, wherein the index is selected using the symmetric key and the parameter.

15. The apparatus of claim 14, wherein the index is selected using an XOR operation on, or an Advanced Encryption Standard (AES) algorithm applied to, the symmetric key and the parameter.

16. The apparatus of claim 1, wherein an initial cyclic shift associated with the sequence is selected using the symmetric key.

17. The apparatus of claim 16, wherein the initial cyclic shift is selected using an XOR operation on, or an AES algorithm applied to, a bit associated with the initial cyclic shift and the symmetric key.

18. The apparatus of claim 16, wherein the one or more processors are further configured to:
maintain a counter across slots, symbols, or component carrier indices,
wherein the symmetric key is modified according to the counter.

19. The apparatus of claim 16, wherein the one or more processors are further configured to:
receive a parameter, wherein the initial cyclic shift is selected using the symmetric key and the parameter.

20. The apparatus of claim 19, wherein the initial cyclic shift is selected using an XOR operation on, or an AES algorithm applied to, the symmetric key and the parameter.

21. The apparatus of claim 1, wherein the sequence is based at least in part on a computer generated sequence to which the symmetric key is added.

22. The apparatus of claim 1, wherein the sequence is based at least in part on an initial cyclic shift to which the symmetric key is added.

23. An apparatus for wireless communication at a network entity, comprising:
a memory; and
one or more processors, coupled to the memory, configured to:
receive a sequence associated with an acknowledgement status; and
decode the sequence using a symmetric key.

24. The apparatus of claim 23, wherein the symmetric key is determined using channel reciprocity at a physical layer.

25. The apparatus of claim 23, wherein the symmetric key is determined using a higher layer of the network entity.

26. The apparatus of claim 23, wherein the acknowledgement status comprises a hybrid automatic repeat request (HARQ) acknowledgement, a HARQ negative-acknowledgement, or a combination thereof.

27. The apparatus of claim 23, wherein the sequence is received on a physical uplink control channel (PUCCH).

28. The apparatus of claim 27, wherein the sequence is formatted according to format 0 associated with the PUCCH.

29. An apparatus for wireless communication at a user equipment (UE), comprising:
a memory; and
one or more processors, coupled to the memory, configured to:
encode an acknowledgement status using a symmetric key; and
transmit a sequence associated with the encoded acknowledgement status.

30. The apparatus of claim 29, wherein the sequence is based at least in part on a codepoint that is selected according to the symmetric key, and the codepoint is selected using an XOR operation on, or an Advanced Encryption Standard (AES) algorithm applied to, the symmetric key and one or more bits representing the acknowledgement status.
